(19) United States
(12) Patent Application Publication
(10) Pub. No.: US 2004/0256606 A1
(43) Pub. Date: Dec. 23, 2004

(54) Transmission support method and apparatus

(76) Inventor: Jay Kelso, Terrace (CA)

Correspondence Address: DONALD V. TOMKINS, C/O MILLER THOMSON LLP, 740, 10150 - 100 STREET, EDMONTON, AB, T5J 0P6, CA

(21) Appl. No.: 10/463,423

(22) Filed: Jun. 18, 2003

(51) Int. Cl. B60P 1/00

(52) U.S. Cl. 254/2 R

(57) ABSTRACT

A method and apparatus for stabilizing an irregularly-shaped object on a support surface use a deformable, weight-bearing body interposed between the irregularly-shaped object and the support surface. The deformable body has a deformable upper surface, and is adapted to deform under the weight of an object resting upon it such that its upper surface will substantially conform to the contours of the contacting portion of the object. The deformable body is further adapted to be capable of bearing the weight of the irregularly-shaped object without rupture or fracture, such that the deformed configuration of the deformable body remains substantially unchanged when the object is positioned on the deformable body in a given orientation. The deformable body in its deformed configuration provides lateral stability to the irregularly-shaped object so as to inhibit or prevent rocking or tipping.

### FIELD OF THE INVENTION

The present invention relates to a method and apparatus for providing stable temporary support for irregularly-shaped objects. More particularly, the invention relates to a method and apparatus for supporting irregularly-shaped equipment components such as automotive transmissions for purposes including removal, servicing, and reinstallation.

### BACKGROUND OF THE INVENTION

In removing a motor vehicle transmission for service or replacement, it is commonly necessary to raise the vehicle on a hoist and then remove the transmission using a vertically adjustable support apparatus of some kind. The support apparatus is raised so as to supportingly engage the bottom of the transmission, whereupon the transmission may be disconnected from the vehicle and the support apparatus may be lowered, thus withdrawing the transmission from the vehicle. The transmission may then be transferred to a work station for servicing or repair, or it may be discarded and replaced with a new transmission. For reinstallation, the repaired or new transmission is positioned beneath the hoist-supported vehicle and then raised up into the vehicle.

When handling a transmission for the foregoing purposes, it is important to provide it with not only vertical support but also lateral stability, such that the transmission will not be prone to tilt or rock fore or aft or to one side. Otherwise, it may be difficult to align the transmission properly with other drive train components during reinstallation, and any lateral instability may also hamper removal of the transmission. During servicing or repair, lateral instability may make it difficult to position the transmission in a preferred orientation for convenient access to the parts or areas being serviced or repaired. Moreover, lateral instability adds to the risk of injury for workers manipulating or servicing the transmission, and generally makes the handling of the transmission more awkward and inefficient.

Clearly, then, it is desirable to support transmissions in laterally stable fashion during removal, servicing, and installation. However, the provision of lateral stability is complicated by the fact that transmissions are typically of irregular shape, with lower surface contours that may not be conducive to stable bearing on a flat support surface. As well, transmissions often have an offset center of gravity such that they may tend to tilt to one side when set on a support surface. Further complicating the problem is the fact that the size and shape of transmissions vary with manufacturer and model.

Although these problems have been discussed in the specific context of vehicle transmissions, they are also relevant to the handling of other cumbersome and irregularly-shaped equipment components that are typically removable by lowering out of a vehicle, such as differentials, transaxles, and transfer cases. Similar problems may also arise in handling irregularly-shaped components that are removed by being hoisted upward out of a vehicle, in which case it may be desirable for the hoisted component to be lowered onto and supported in stable fashion on a support surface.

For the foregoing reasons, support apparatus used in removing, manipulating, or reinstalling a transmission or other irregularly-shaped equipment component requires some means of stabilizing the transmission in a desired orientation. Various ways of doing so may be found in the prior art; see, for example, U.S. Pat. No. 2,523,734 (Stephenson et al., Sep. 26, 1950), U.S. Pat. No. 2,747,837 (Turner, May 29, 1956), U.S. Pat. No. 2,838,278 (Johnsen, Jun. 10, 1958), U.S. Pat. No. 3,062,500 (Arnes et al., Nov. 6, 1962), U.S. Pat. No. 3,559,981 (Abshear, Feb. 2, 1971), U.S. Pat. No. 3,958,793 (Garate, May 25, 1976), U.S. Pat. No. 4,269,394 (Gray, May 26, 1981), U.S. Pat. No. 4,445,667 (Webb, May 1, 1984), U.S. Pat. No. 5,139,233 (Goss, Aug. 18, 1992), U.S. Pat. No. 5,156,375 (Liegel et al., Oct. 20, 1992), U.S. Pat. No. 5,372,353 (West, Dec. 13, 1994), U.S. Pat. No. 6,089,545 (Norman et al., Jul. 18, 2000), and U.S. Pat. No. 6,149,144 (Ha, Nov. 21, 2000).

In each of these references, the disclosed device or apparatus includes mechanical elements which are adjustable to adapt to the shape of the transmission or other irregularly-shaped equipment component being handled. These devices have practical disadvantages in that each of them have a number of adjustable mechanical elements that require fairly precise setting or adjustment in order for the devices to supportingly adapt to the shape of the particular equipment component being handled. This procedure takes time and labour. Furthermore, the adjustable mechanical elements are prone to wear, and therefore may require periodic repair or replacement.

For the foregoing reasons, there is a need for an improved and simplified method and apparatus for supporting an irregularly-shaped equipment component on a support surface in laterally stable fashion, without need for adjustable mechanical elements requiring manipulation and adjustment for stable engagement and support of the equipment component. The present invention is directed to this need.

### BRIEF SUMMARY OF THE INVENTION

In general terms, the invention provides a method and apparatus for both supporting and laterally stabilizing an irregularly-shaped object on a support surface, using a deformable body of appropriate dimensions and structural strength interposed between the irregularly-shaped object and the support surface. The deformable body has a deformable upper surface, and is adapted to deform under the weight of an object resting upon it such that the contour of its upper surface deforms so as to conform substantially to the contours of the contacting portion of the object. The deformable body is further adapted to be capable of bearing the weight of the irregularly-shaped object without rupture or fracture, such that the deformed configuration of the deformable body remains substantially unchanged when the object is positioned on the deformable body in a given orientation.

Therefore, when an irregularly-shaped object is positioned on the deformable body, the weight of the object causes the deformable body to deform such that the upper surface of the deformable body substantially adapts to the contours of the contacting portion of the object, while the weight of the object is transferred through the deformable body to the support surface. At the same time, the deformable body in its thus-deformed configuration provides lateral stability to the irregularly-shaped object so as to inhibit or prevent rocking or tipping. If it is desired to change the position or orientation of the object, the object may be lifted and reoriented as desired and then lowered once again onto the deformable body, which will then deform to adapt to the object in its changed orientation.

Accordingly, the present invention in one aspect is a method of supporting an object having an irregularly-contoured lower surface, including the steps of providing a support member having an upper surface; positioning a weight-bearing deformable body on the upper surface of the support member, said deformable body having a deformable upper surface; and engaging the lower surface of the object with the upper surface of the deformable body such that at least a portion of the weight of the object is transferred to the deformable body at least a portion of the upper surface of the deformable body is deformed to substantially conform to the contours of at least a portion of the lower surface of the object, and at least a portion of the weight of the object is transferred through the deformable body to the support member.

The method of the invention may further involve the step of raising the support member with the deformable body positioned thereupon, so as to engage the lower surface of the object with the upper surface of the deformable body. In an alternative embodiment, the method may further involve the step of lowering the object, so as to transfer the weight of the object to the deformable body.

In another aspect, the invention is an apparatus for supporting an object having an irregularly-contoured lower surface, comprising a support member having an upper surface, and a deformable body having a deformable upper surface, said deformable body being adapted for being positioned on the upper surface of the support member, and further being adapted to deformably bear the weight of the object.

In preferred embodiments of the method and apparatus of the invention, the support member is substantially planar and horizontal, and the support member is supported by a stand. In alternative embodiments, the upper surface of the support member may be concave, so as to inhibit lateral displacement of the deformable body. The support member may include an upstanding curb or lugs adjacent to its perimeter, to inhibit lateral displacement of the deformable body relative to the support member.

Also in preferred embodiments, the stand includes vertical adjustment means, by means of which the support member may be selectively raised or lowered. The stand may have rolling means, to facilitate transfer of the irregularly-shaped object to another location while supported on the stand.

The deformable body may comprise a sealed pouch made from a flexible sheet material, and containing a weight-bearing filler material. The flexible sheet material may be permeable or non-permeable. The flexible sheet material may be a woven fabric of either natural or synthetic fibers.

In preferred embodiments, the filler material will be a granular material such as sand or gravel. Alternatively, the filler material may comprise pellets made from natural or synthetic materials of suitable properties.

In yet further embodiments, the deformable body may comprise a substantially homogeneous mass fashioned from a plastically deformable material.

### BRIEF DESCRIPTION OF THE DRAWINGS

Embodiments of the invention will now be described with reference to the accompanying figures, in which numerical references denote like parts, and in which:

FIG. 1 is an elevation of an embodiment of the apparatus of the invention, showing a deformable body positioned on a support member, ready to receive an irregularly-shaped object.

FIG. 2 is an elevation of an embodiment of the apparatus of the invention, illustrating the deformable body in a deformed configuration induced by imposition of the weight of an irregularly-shaped object.

### DETAILED DESCRIPTION OF THE PREFERRED EMBODIMENT

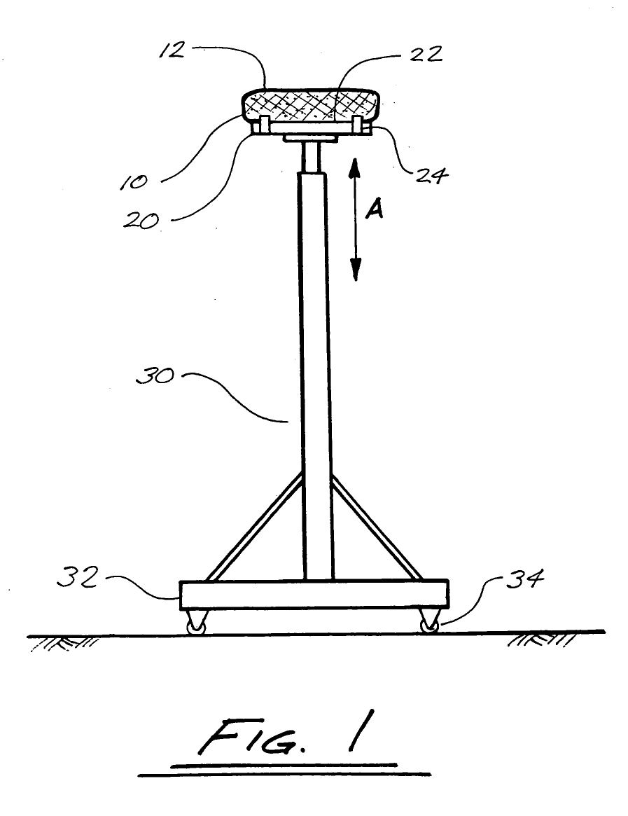

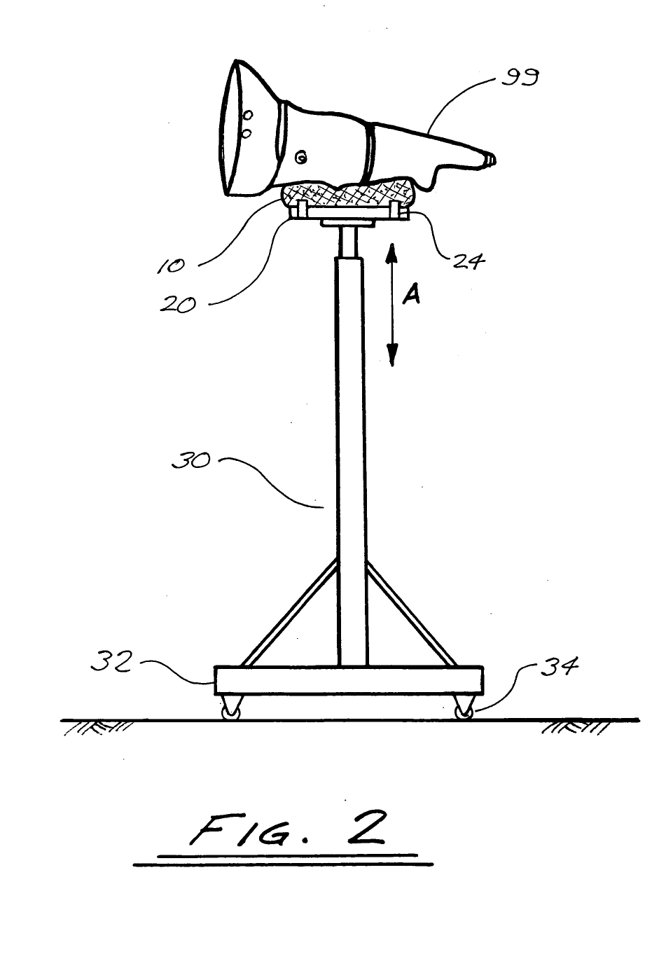

As illustrated in FIGS. 1 and 2, the apparatus of the present invention comprises a weight-bearing deformable body 10 with a deformable upper surface 12, and a support member 20 connected to a stand 30 having a base 32. The stand 30 is shown conceptually in the Figures, and may be of any suitable shape and construction. The support member 20 has an upper surface 22, and the deformable body 10 is adapted to be positioned upon the upper surface 22 of the support member 20. In the preferred embodiment, the upper surface 22 is substantially planar, but it does not necessarily have to be completely flat or smooth. The upper surface 22 may be concave or may have more than one level, which configurations may be advantageous to accommodate the shape of some equipment components, or to inhibit lateral displacement of the deformable body 10. The upper surface 22 may have one or more ribs or upward projections, for engaging the deformable body 10 to inhibit lateral displacement thereof.

In one embodiment, the support member 20 is fixed such that its upper surface 22 is in a substantially horizontal orientation. In an alternative embodiment, the support member 20 has angular adjustment means (not shown) of any well-known type, for adjusting the orientation of the upper surface 22 of the support member 20, which may be beneficial to accommodate some types of equipment. In the preferred embodiment, the support member 20 may have one or more upstanding edge members 24 in selected locations at or near the one or more edges of the upper surface 22, to inhibit lateral displacement of the deformable body 10 and minimize the risk that it might slide off the support member 20. The edge members 24 may be provided in the form of spaced lugs or elongate curb sections, or both.

The deformable body 10 is adapted to deform under the weight of a transmission or other irregularly-shaped object resting upon it, such that the contour of its upper surface 12 deforms so as to conform substantially to the contours of the contacting portion of the object, while also being capable of bearing the weight of the irregularly-shaped object without rupture or fracture. As previously noted, the deformable body 10 has a deformable upper surface 12. The deformable body 10 may have other deformable surfaces as well, but this is not essential to the invention. The dimensions and structural properties of the deformable body 10 may be selected to suit the particular object intended to be supported using the apparatus of the invention.

In the preferred embodiment, the deformable body 10 is a pouch containing a weight-bearing filler material. The pouch is fashioned from a flexible sheet material, which may be either permeable or impermeable. The sheet material may be a fabric made of natural fibers, such as cotton, wool, or burlap. Alternatively, the sheet material may be a fabric made of a synthetic material, such as polypropylene or fiberglass. The pouch is sealed by stitching or other appropriate means to prevent or minimize the risk of leakage or escape of the filler material.

As a practical consideration, the choice of sheet material for the pouch may depend at least in part on the weight and shape of the object to be supported. Logically, a sheet material of higher tensile strength or tear resistance may be necessary or desirable for a pouch intended for use with a particularly heavy object or an object having prominent protrusions that might induce high localized stresses in the sheet material.

In the preferred embodiment, the filler material for the pouch will be a granular material such as sand or gravel. Alternatively, the filler material may comprise pellets made of synthetic or natural materials (examples of which may include high-density polyethylene or hardwood), and of suitable dimensions and material properties so as to interact, when enclosed in a flexible pouch, in deformably weight-bearing fashion in response to the imposition of the weight of an irregularly-shaped object.

In an alternative embodiment, the deformable body 10 may be, or may include as an element thereof, a substantially homogeneous mass fashioned from a plastically deformable material capable of supporting the weight of an irregularly-shaped object while maintaining a deformed shape induced by the imposition of the weight of the object. The plastically deformable material may comprise a natural clay material, or a synthetic material having suitable plastic qualities. As used in this paragraph and elsewhere in this patent document, the terms “plastic” and “plastically” refer to a material's ability to deform and maintain the deformed configuration, not in the sense referring to the chemical composition of the material. However, this does not exclude the possibility that a plastically deformable material in the context of this document may comprise a “plastic” material in that alternative sense.

Irrespective of its construction, the deformable body 10 does not have to be of any particular shape. When provided in the form of a pouch containing filler material, the deformable body 10 may conveniently have a pillow-like configuration, with a circular, elliptical, square, or rectangular perimeter shape. The average height or thickness of the filled pouch may be selected to suit particular applications. In this regard, it will be readily appreciated that, as a general rule, increased thickness will enhance the performance and effectiveness of the pouch-type deformable body 10.

In the preferred embodiment, the stand 30 includes vertical adjustment means (not shown), by means of which the support member may be selectively raised or lowered, as conceptually indicated by arrows A in FIGS. 1 and 2. The vertical adjustment means may be of any suitable type well known in the art, examples of which may include a hydraulic cylinder, a threaded jack rod, a rack-and-pinion assembly, or a ratchet assembly. The vertical adjustment means may be manually operable, or may in certain embodiments be operable by an electric motor, which in turn may be battery-operated.

Also in the preferred embodiment, the base 32 of stand 30 will have rolling means 34 such as wheels, casters, or similar well-known devices, to facilitate movement of the stand 30 across a floor surface so that an irregularly-shaped object can be moved from one location to another while supported on the apparatus.

The operation of the present invention will be easily understood from reference to FIGS. 1 and 2. The deformable body 10 is positioned as desired on the upper surface 22 of the support member 20. All or part of the weight of a transmission 99 (or other object desired to be supported) may then be imposed onto the deformable body 10, by engaging at least a portion of the lower surface of the transmission 99 in weight-bearing contact with the upper surface 12 of the deformable body 10. This causes the upper surface 12 of the deformable body 10 to deform so as to substantially conform with the contours of the contacting portion of the lower surface of the transmission 99. As a result, the transmission 99 becomes nestled down into the deformable body 10, such that the deformable body 10 in its thus deformed configuration provides a degree of lateral support and restraint to the transmission 99. At the same time, the weight of the transmission 99 is transferred to the deformable body 10 in substantially continuous fashion along and across the irregularly-shaped interface between the transmission 99 and the upper surface 12 of the deformable body 10, and from the deformable body 10 to the supporting member 20 and stand 30.

In one embodiment of the method of the invention, the deformable body 10 is brought into weight-bearing engagement with an irregularly-shaped object by raising the support member 20 with the deformable body 10 resting on the upper surface 22 of the support member 20. This may be conveniently accomplished using an embodiment of the apparatus having a vertically-adjustable stand 30. To provide a particularly useful and common example, a vehicle requiring removal of its transmission may be raised on a conventional service garage hoist. The apparatus of the present invention, having a vertically-adjustable stand 30 with rolling means 34, and with a deformable body 10 of appropriate size and properties positioned on the upper surface 22 of the support member 20, may be moved into position under the hoist-supported vehicle directly below the transmission. Using the vertical adjustment means of the stand 30, the support member 20 may be raised until the deformable body 10 comes close to or into actual contact with the lower portion of the transmission. The transmission may then be disengaged from the vehicle, whereupon its weight will be transferred to the deformable body 10, which will in turn deform to adapt to the shape of the transmission. The support member 20 may then be lowered so that the stand 30, with the transmission supported thereon, may be rolled away from the vehicle to a desired location, for servicing, repair, or disposal as appropriate.

Alternatively, the deformable body 10 may be brought into weight-bearing engagement with an irregularly-shaped object by lowering the object onto the deformable body 10 resting on the support member 20. This could be accomplished in the preceding example by using the service garage hoist to lower the vehicle until the transmission is close to or in contact with the deformable body 10. Upon disengagement of the transmission from the vehicle, the service garage hoist would be used to raise the vehicle so that the stand 30 could be rolled away, with the transmission supported thereon.

In a further alternative procedure, it may be desirable to support an irregularly-shaped object that has already been disengaged from a vehicle or other piece of equipment. In this situation, the object may be simply positioned on the apparatus of the present invention using a conventional hoist or crane with suitable lifting gear such as cables or chains.

As will be appreciated from the preceding descriptions and examples, the method and apparatus of the invention may be used to provide both vertical and lateral support to a transmission or other object of irregular shape, without requiring mechanical components that need to be manipulated or adjusted to accommodate the shape of the object. The deformable body 10 automatically deforms to accommodate the shape of the object due to the force of gravity (i.e., the weight of the object). The properties of the deformable body 10 allow it to hold a stable deformed shape so that it provides lateral restraint to the object while also supporting the weight of the object. If it is desired to change the orientation of the supported object, the object may be withdrawn from and then repositioned upon the deformable body 10 as desired, whereupon the deformable body 10 will deform into a shape to accommodate the contours of the object in its changed orientation.

It will be readily seen by those skilled in the art that various modifications of the present invention may be devised without departing from the essential concept of the invention, and all such modifications are intended to be included in the scope of the claims appended hereto.

In this patent document, the word “comprising” is used in its non-limiting sense to mean that items following that word are included, but items not specifically mentioned are not excluded. A reference to an element by the indefinite article “a” does not exclude the possibility that more than one of the element is present, unless the context clearly requires that there be one and only one such element.

What is claimed is:

1. A method of supporting an object having an irregularly-contoured lower surface, said method comprising the steps of:
(a) providing a support member having an upper surface;
(b) positioning a weight-bearing deformable body on the upper surface of the support member, said deformable body having a deformable upper surface; and
(c) engaging the lower surface of the object with the upper surface of the deformable body such that:
c.1 at least a portion of the weight of the object is transferred to the deformable body;
c.2 at least a portion of the upper surface of the deformable body is deformed to substantially conform to the contours of at least a portion of the lower surface of the object; and
c.3 at least a portion of the weight of the object is transferred through the deformable body to the support member.

2. The method of claim 1 wherein the step of engaging the lower surface of the object with the upper surface of the deformable body comprises the further step of raising the support member with the deformable body positioned thereupon.

3. The method of claim 1 wherein the step of engaging the lower surface of the object with the upper surface of the deformable body further comprises the step of lowering the object toward the deformable body.

4. The method of claim 1 wherein the support member has one or more upstanding edge members.

5. The method of claim 1, further comprising the step of providing a stand for supporting the support member.

6. The method of claim 5 wherein the stand includes vertical adjustment means, whereby the support member may be selectively raised or lowered.

7. The method of claim 5 wherein the stand comprises rolling means, to facilitate horizontal movement of the stand.

8. The method of claim 1 wherein the deformable body comprises a pouch made from a flexible sheet material, said pouch containing a weight-bearing filler material.

9. The method of claim 8 wherein the flexible sheet material is non-permeable.

10. The method of claim 8 wherein the flexible sheet material is permeable.

11. The method of claim 8 wherein the flexible sheet material comprises a fabric.

12. The method of claim 11 wherein the fabric comprises natural fibers.

13. The method of claim 11 wherein the fabric comprises synthetic fibers.

14. The method of claim 8 wherein the filler material is a granular material.

15. The method of claim 14 wherein the granular material comprises sand.

16. The method of claim 8 wherein the filler material is a pelletized material.

17. The method of claim 1, wherein the deformable body comprises a substantially homogeneous mass of plastically deformable material.

18. An apparatus for supporting an object having an irregularly-contoured lower surface, said apparatus comprising:
(a) a support member having an upper surface; and
(b) a deformable body having a deformable upper surface, said deformable body being adapted for being positioned on the upper surface of the support member, and further being adapted to deformably bear the weight of the object.

19. The apparatus of claim 18 wherein the support member has one or more upstanding edge members.

20. The apparatus of claim 18 further comprising a stand for supporting the support member.

21. The apparatus of claim 20 wherein the stand comprises vertical adjustment means, whereby the support member may be selectively raised or lowered.

22. The apparatus of claim 20 wherein the stand comprises rolling means, to facilitate horizontal movement of the stand.

23. The apparatus of claim 18 wherein the deformable body comprises a pouch made from a flexible sheet material, said pouch containing a weight-bearing filler material.

24. The apparatus of claim 23 wherein the flexible sheet material is non-permeable.

25. The apparatus of claim 23 wherein the flexible sheet material is permeable.

26. The apparatus of claim 23 wherein the flexible sheet material comprises a fabric.

27. The apparatus of claim 26 wherein the fabric comprises natural fibers.

28. The apparatus of claim 26 wherein the fabric comprises synthetic fibers.

29. The apparatus of claim 23 wherein the filler material is a granular material.

30. The apparatus of claim 29 wherein the granular material comprises sand.

31. The apparatus of claim 23 wherein the filler material is a pelletized material.

32. The apparatus of claim 18, wherein the deformable body comprises a substantially homogeneous mass of plastically deformable material.
